(19) United States
(12) Patent Application Publication
(10) Pub. No.: US 2008/0027607 A1
(43) Pub. Date: Jan. 31, 2008

(54) Assistance System for Motor Vehicles

(75) Inventors: Ludwig Ertl, Donaustauf (DE); Thorsten Kohler, Lindau (DE); Hans-Wilhelm Ruehl, Solms (DE); Dirk Zittlau, Stockelsberg (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/587,198

(22) PCT Filed: Apr. 18, 2005
(86) PCT No.: PCT/EP05/51695

§ 371 Date: Oct. 23, 2006

(30) Foreign Application Priority Data
Apr. 21, 2004 (DE) 10 2004 019 337.1

(51) Int. Cl. G06G 7/76; G01C 21/30; G06G 7/78; G06F 7/00

(52) U.S. Cl. 701/36; 701/123; 701/208; 701/213; 701/301

(57) ABSTRACT

An assistance system for motor vehicles, in particular an electronic rally-copilot, an over-taking assistant, or right-of-way assistant, includes at least one control unit, which selects data from at least three groups of global, local, and internal data. The selection is by way of a specification of a driver known by the control unit and they are connected together in such a manner that an output signal can be produced relating to the driving dynamics of the motor vehicle. Further, there is provided an assistance system, which simultaneously processes, in an advantageous manner, data prepared by three groups (and/or with the specification of the driver from four groups). Redundancy can be established in an advantageous manner, which is determined, in particular for security-related uses. It can be used, in particular, as a rally-copilot, an over-taking assistant and/or right-of-way assistant for modern vehicles.

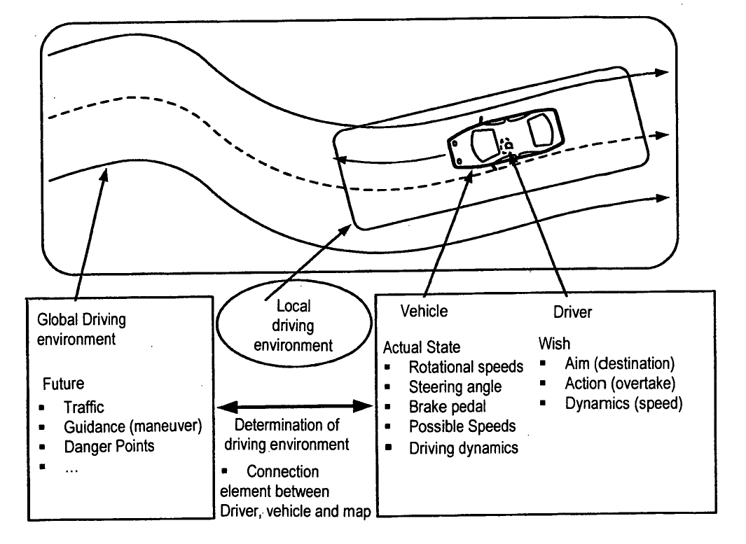

The invention relates to an assistance system for motor vehicles, in particular an electronic rally-copilot, an overtaking assistant or a right-to-left assistant.

In future, intelligent assistance systems will become increasingly important in modern motor vehicles. At present, a few systems are available to both the driver and/or the motor vehicle. They are in particular as follows:
Navigation systems;
Systems such as ABS (Anti-lock Brake System), ESP (Electronic Stability Program) or ASR (Traction Control system), which act automatically and without intervention by the motor vehicle driver; as well as
Cruise Control (CC) or ACC (Adaptive Cruise Control) and LDW (Lane Departure Warning).

The known assistance systems are characterized in that, above their sensor information, they do not exchange any higher-order information with one another. For example, the navigation system uses the rotational speeds of the wheels, as do ABS and ESP, but it does not know whether the ABS or the ESP are exercising control at that precise moment.

In order to be able to utilize the full extent of the possibilities of driver assistance systems, it is necessary to link the information at a higher system level.

The object of the present invention is to create an improved assistance system for motor vehicles, which avoids previously mentioned disadvantages.

This object is achieved according to the invention by the features of the independent claims.

Advantageous embodiments and further developments, which can be used individually or in combination with one another, are the object of the dependent claims.

According to the invention, the assistance system for motor vehicles comprising at least one control unit, which for a specification made by the driver, selects from at least three groups of so-called global, local and internal data, at least one item of data in each case and links this data together in such a way that an output signal related to the driving dynamics of the motor vehicle can be generated as a function thereof.

The driver specification preferably includes the following: the destination entered into a navigation system; the gear selected; the position of the gas pedal; the position of the other pedals; the angle at which the steering wheel is turned; the set or non-set turn signal indicator position; the light settings; the settings of the Cruise Control (CC) or the ACC; and/or so forth.

The global data typically includes: the global course of the roadway lying ahead of the motor vehicle; the type of roadway such as an expressway, a country road, etc.; a road barrier; the number of traffic lanes; bridges; tunnels; traffic signs; and/or so forth. According to the invention, the global data is preferably generated based on prepared map data, as well as a position determination of the motor vehicle, for example, by means of GPS, odometry, UMTS and/or the like in a processing unit, which can either form part of the control unit or can also be independent from it.

The local data typically includes data such as: the local course of the roadway lying ahead of the motor vehicle; its own traffic lane; the curve of the roadway; the type of road surface markings; additional road users with their relative positions, speeds, accelerations and so forth for instance with regard to one's own motor vehicle; roadside developments such as crash barriers, traffic signs, tunnels, arrows that show a curve in the road, zebra crossings, parking bays; the position of one's own motor vehicle in the traffic lane, the yaw angle, the change in the yaw angle, the pitch angle, the change in the pitch angle, the roll angle and the change in the roll angle of the motor vehicle relative to the traffic lane or the level of the traffic lane surface. According to the invention, the local data is made available in a preferred manner by means of so-called environment sensors. In accordance with the invention said environment sensors are used for the generation of the local data such as in particular the front area, if required, also the side areas and the rear, of the camera systems that record the motor vehicle; ACC radars; 24 GHz or 77 GHz radar sensors, LIDAR sensors; ultrasound sensors; and/or so forth.

The internal data for example includes: the wheel speed; the yaw angle; the engine speed; the gear selected; the temperature of the individual units; the current fuel consumption; the tire pressure, the type of tires; the age of the tires; and/or more besides. According to the invention, the internal data is preferably made available by means of internal sensors in the motor vehicle such as wheel speed sensors; yaw angle sensors; engine management; fuel gauge; tire pressure gauge; rain sensor; and/or more besides.

Preferably according to the invention the output signal relating to the driving dynamics of the motor vehicle is an acoustic, a visual and/or a haptic warning signal.

As an alternative to this or along with it, the output signal relating to the driving dynamics of the motor vehicle intervenes independently into defined systems such as the brakes, the steering, etc. of the motor vehicle.

By contrast with the assistance systems known from the prior art, the present invention makes a significant improvement in an advantageous manner by linking together information from the three above-mentioned appropriate data groups in the light of a fourth data group, namely the (known) specifications of the driver of a motor vehicle, in such a manner that output signals can be produced relating to the driving dynamics of the motor vehicle, which exploit the performance of the whole system to the optimum. In this case, a data group is not compelled to make available the whole set of sensor systems and all the information. Instead, a suitable subset and a subset adapted to the problem are sufficient. Even for those cases where one of the sources of information is not available from time to time, the scope of the uses can be limited accordingly.

Additional details and further advantages of the invention are described below using preferred exemplary embodiments as well as the accompanying drawings.

The single drawing shows schematically the three data groups: the global data (global driving environment), the local data (local driving environment), the internal data (motor vehicle) as well as the driver of a motor vehicle with his intentions or wishes, which in the final analysis is equivalent to a fourth data group.

The present invention is based on the idea of always verifying the global information with the local environment detection and in addition of comparing the precise position and the driving dynamics of one's own motor vehicle relative to the global world with the local and internal information. Amongst other things, redundancy can then advantageously be produced, which is especially decisive for security-related applications.

The invention is explained below with reference to a rally-copilot, an overtaking assistant, as well as a right-to-left assistant by way of example.

An electronic rally-copilot fitted to the assistance system according to the invention is preferably characterized by:
a navigation system or another link between the map and the position on the map;
an identification of the traffic lane, i.e. the position of the ego car in the traffic lane and the roadway, the curve of the roadway and the traffic lane model, the yaw angle of the ego car to the traffic lane, as well as optional pitch angles and roll angles;
the driving dynamics of the ego car, given in particular from the rotational speeds and possible additional data such as the yaw angle sensor and, in addition, if required optional well-known values for the possible driving dynamics of the motor vehicle and/or, on the other hand, an optional rain sensor (hence, a resulting estimation of the coefficient of friction) as well as additional options for estimating the coefficient of friction of the road; as well as
the driver of a motor vehicle who specifies the driving dynamics (the speed, the cutting of a corner, etc.).

In a first embodiment of the rally-copilot, the motor vehicle driver receives an acoustic, a visual and/or a haptic warning, if the speed of the motor vehicle is for example too high for the approaching curve, namely: “Attention, too fast for next curve”. Moreover, the radius of the curve is known from the navigation database. In addition, a camera system determines in an advantageous manner the radius of the curve lying ahead of the motor vehicle as well as the position of the motor vehicle in the traffic lane and on the curve.

In a further embodiment of the rally-copilot, the yaw angle of the motor vehicle to the traffic lane, the cutting of a corner, the driving dynamics from the rotational speeds, the steering angle, the optional measured values of a gyroscope, the optional coefficient of friction of the tires are evaluated in addition and the warning is thereby qualified even further.

Alternatively or cumulatively: in the case of warning signals to the motor vehicle driver, the rally-copilot intervenes in or acts on the brake and automatically slows down the motor vehicle if the driving dynamics do not allow the passing through of the approaching curve. Over and above that, provision has also been made for interventions in the steering, if required, also the shape of only signaling impulses, as well as in the running gear or the brakes of the individual wheels.

In a further embodiment of the rally-copilot, the motor vehicle driver receives notifications of and information about an approaching curve such as, for example: “Next curve left grade 2”, it being possible that the curves have for example been classified according to their radius. On the other hand, it is also possible to indicate directly the angle of the curve. However, the notification of, for example: “Attention, brow of a hill, then 100 m right-hand curve grade 3”, it being possible for the camera to identify from the pitch angle of the motor vehicle relative to the road surface that the brow of a hill and the pedal positions.

As an alternative the rally-copilot can issue notifications, which refer to the recommended speed for a specific curve design or to the maximum permissible speed for a curve, for example: “Left-hand curve in 150 m, speed 90”, and which are also meaningful for the normal drivers of a motor vehicle.

Also conceivable are other warnings based on the balance between the local environment and the global environment. Examples are pedestrian crossings, traffic signs (right-of-way, speed), arrows that show a curve in the road, intersections and more besides.

A preferred further embodiment of the rally-copilot refers to the supplementary processing of information by secondary systems in the case of missing or incorrect information by the primary system, or in the case of a failure of the primary system. For example, the navigation system should provide the primary information for the course of the road. However, if a new stretch of the road (for example, a diversion) has not yet been recorded on an out-of-date map, without an identification of the traffic lane it remains unclear whether or not the motor vehicle follows a road, or is being steered so to speak “off-road” for example to a parking lot or on a private property. By means of an identification of the traffic lane, it is possible for the inventive assistance system according to the invention to specifically output a suitable warning such as for example: “Unknown road. No navigation possible”, etc. in an advantageous manner.

According to the invention, an electronic overtaking assistant to be fitted to the assistance system as an alternative or to complement the rally-copilot is preferably characterized by:
a navigation system or another link between the map and the position on the map;
a recording of the driving environment, which records the traffic lane, a motor vehicle to be overtaken, optionally the oncoming traffic and/or the traffic signs;
the current motor vehicle dynamics; as well as
a clear identification of the motor vehicle driver who would like to overtake other road users, by using the turn signal indicators, the steering angle, the pedal positions, etc. for example

In a first embodiment of the overtaking assistant the camera system preferably identifies a motor vehicle traveling (at a short distance) ahead and the crossing of the center line or the motor vehicle driver uses the turn signal indicators, whereby the overtaking assistant is informed about the wish of the motor vehicle driver to initiate an overtaking process. In this case, the system then in particular signals a warning if the section of the route is not suitable for an overtaking process in accordance with the map data, for example, in cases of sections of the route with straight sections which are too short, or with hidden sections or close to intersections or T-junctions, etc.

In a further embodiment, the overtaking assistant takes into account the speed of one's own motor vehicle, as well as optionally the speed of the motor vehicle to be overtaken recorded by an environment sensor system in order to produce a warning if required.

In a further embodiment, after warning the driver, the overtaking assistant informs them about the expected distance to the next suitable section of the route for an overtaking maneuver.

In a further embodiment, the overtaking assistant either as a result of the navigation data or as a results of detection of oncoming traffic, advantageously has knowledge of whether or not there is likely to be oncoming traffic on the section of the route (not for example on the expressway). Warnings would then only be issued in the case of single-lane roadways or in the case of multilane roadways in which it is possible to move into the oncoming traffic lane.

As an alternative or in addition it is possible that either the navigation database knows about a no-overtaking zone or the camera system identifies a no-overtaking sign or a solid line, or said sign is transmitted by means of a transponder.

In a further embodiment of the overtaking assistant, a side sensor system, for example, a camera or a 24 GHz radar or a 77 GHz radar or a Lidar scanner or a so-called TOF (Time of Flight) camera as described in EP 1 159 636 B1 or DE 101 38 531 A1, identifies the position of the motor vehicle to be overtaken, in particular relative to the ego car, and for example sends a message once the ego car has concluded the process including the safety distance.

In a further embodiment of the overtaking assistant, the environment sensor system identifies oncoming traffic and produces a warning if the overtaking process becomes critical.

Finally, the environment sensor system of the overtaking assistant identifies other obstacles such as animals or pedestrians in the overtaking lane and generates a warning if the overtaking process becomes critical.

The electronic overtaking assistant to be fitted to the assistance system according to the invention functions equally well, in an advantageous manner, during the day and at night, with security-related advantages being emphasized in the last-mentioned scenario.

According to the invention, an electronic right-to-left assistant to be fitted to the assistance system as an alternative or in addition to the rally-copilot and/or to an overtaking assistant is preferably characterized by:
a navigation system or another links between the map and the position on the map;
an environment sensor system, which identifies crossing traffic or road users having right of way or optionally the exact position of the intersection as well as optional traffic lights, arrows that show a curve in the road and other traffic signs;
the speed and the position of the brake pedal of the motor vehicle or optionally by an additional sensor for determining the line of vision of the motor vehicle driver; as well as
the motor vehicle driver who does not apply the brakes and possibly overlooks other road users who may have right of way or from whom the right of way is taken.

In a first embodiment of the right-to-left assistant, the navigation system identifies right-to-left intersections. In addition the navigation identifies the intersection, but the absence of the right-of-way sign is preferably identified by a camera system and/or a transponder, i.e. the radio signal of a future traffic sign, which will as far as possible, be equipped accordingly. If the environment sensor system identifies a motor vehicle that has right of way, then advantageously a warning can be generated.

As an alternative or in addition to this, the right-to-left assistant takes into account the speed of the other motor vehicle as well as one's own motor vehicle and produces a warning especially if there is danger of a collision.

In a further development of the right-to-left assistant, a braking action is carried out automatically, whereby additional actuators can also be used. In particular, in addition to the braking action, it is also possible to initiate an automatic avoidance process.

Expediently the functionality is not only limited to right-to-left intersections, but to any type of intersection in which one of the road users violates the right-of-way rules. Of course the embodiments here also apply to left-to-right assistants in the British or the Australian flow of traffic. According to the invention, the assistance system automatically switches over from the right-to-left mode if a motor vehicle or a truck is used in other countries.

In a further embodiment of the right-to-left assistant, the traffic lights, the color of the traffic lights, the distances of one's own motor vehicle from the traffic lights, arrows that show a curve in the road, as well as additional signs controlling the direction of said flow of traffic are also taken into account here.

Finally, an additional sensor in the interior of the motor vehicle can measure or roughly classify the line of vision of the motor vehicle driver and hence estimate from this whether or not the motor vehicle driver has perceived the other road user who has the right of way. The warning can then only for example be issued if the other road user was not perceived in this case.

The present invention provides an assistance system for the first time which advantageous simultaneously processes data made available by three groups (or with the specifications of the driver, four groups). One of the advantages of such as system is advantageously to produce redundancy, which is decisive, especially in security-related applications.

This invention is thus especially suitable as a rally-copilot, an overtaking assistant and/or a right-to-left assistant for modern motor vehicles.

1-13. (canceled)

14. An assistance system for a motor vehicle, comprising:
at least one control unit configured to detect a driver specification and, based on the driver specification, to select from three groups of data, at least one item of data each, and to link the selected items of data to each other, and to generate an output signal, based on the linkage, relating to the driving dynamics of the motor vehicle.

15. The assistance system according to claim 14 configured in an electronic rally-copilot, an overtaking assistant, or a right-of-way assistant.

16. The assistance system according to claim 14, wherein the groups of data include global data, local data, and internal data.

17. The assistance system according to claim 14, wherein the driver specification is selected from the group of: a destination entered into a navigation system; a gear selected; a position of an accelerator pedal and a position of other pedals; an angle at which a steering wheel is turned; a turn signal setting, a set turn signal indicator position, a non-set turn signal indicator position; light settings; settings of a cruise control or an adaptive cruise control.

18. The assistance system according to claim 16, wherein the global data are selected from the group consisting of a global course of a roadway lying ahead of the motor vehicle; a type of roadway; a road barrier; a number of available traffic lanes; bridges; tunnels; and traffic signs.

19. The assistance system according to claim 18, which further comprises a computing unit in which the global data is generated based on map data provided, and a position determination of the motor vehicle.

20. The assistance system according to claim 19, wherein the position determination includes at least one of GPS, odometry, and UMTS.

21. The assistance system according to claim 14, wherein the groups of data include local data selected from the group consisting of: a local course of a roadway lying ahead of the motor vehicle; a traffic lane currently traveled by the motor vehicle; a curve of the roadway; a type of road surface markings; additional road users with relative positions thereof, speeds, and accelerations of the additional road users relative to the motor vehicle; peripheral structures; a position of the motor vehicle in the traffic lane, a yaw angle, a change in the yaw angle, a pitch angle, a change in the pitch angle, a roll angle and a change in the roll angle of the motor vehicle relative to the traffic lane or a level of a surface of the traffic lane.

22. The assistance system according to claim 19, wherein the peripheral structures include crash barriers, traffic signs, tunnels, arrows showing a curve in the road, pedestrian crossings, or parking bays.

23. The assistance system according to claim 21, which includes a plurality of environment sensors for generating local data.

24. The assistance system according to claim 23, wherein said environment sensors include sensors selected from the group of sensors monitoring a front area of the vehicle, side areas of the vehicle, a rear of the vehicle, a camera system recording the motor vehicle; ACC radars; 24 GHz radar sensors, 77 GHz radar sensors, LIDAR sensors; and ultrasound sensors.

25. The assistance system according to claim 14, wherein the groups of data include internal data selected from: rotational speed; yaw angle; engine speed; currently selected gear; temperature of individual units; current fuel consumption; tire pressure, type of tires; and age of the tires.

26. The assistance system according to claim 25, which further comprises groups of internal sensors in the motor vehicle for generating the internal data, said sensors including wheel rotational speed sensors; yaw angle sensors; engine control; fuel indicator; tire pressure gauge; and a rain sensor.

27. The assistance system according to claim 14, wherein the output signal relating to the driving dynamics of the motor vehicle is at least one signal selected from the group consisting of acoustic warning signals, visual warning signals, and haptic warning signals.

28. The assistance system according to claim 14, wherein the output signal relating to the driving dynamics of the motor vehicle is provided to intervene independently in defined systems of the motor vehicle.

29. The assistance system according to claim 28, wherein the output signal is provided to intervene independently in the braking system or the steering system.

30. A rally-copilot system in a motor vehicle, comprising an assistance system according to claim 14 including at least one of the following:
a navigation system;
an identification of the traffic lane;
the driving dynamics; and
the specifications of the motor vehicle driver.

31. An overtaking assistant in a motor vehicle, comprising an assistance system according to claim 14 including at least one of the following:
a navigation system;
recording of the driving environment;
the current motor vehicle dynamics; and
the specifications of the motor vehicle driver.

32. A right-of-way assistant in a motor vehicle, comprising an assistance system according to claim 14 including at least one of the following:
a navigation system;
an environment sensor system;
an information item of a speed of the motor vehicle and an information item of a brake pedal position of the motor vehicle; and
the specifications of the motor vehicle driver.
